(19) United States
(12) Patent Application Publication
(10) Pub. No.: US 2023/0096588 A1
(43) Pub. Date: Mar. 30, 2023

(54) APPARATUS AND METHOD FOR UNKNOWN PUCCH SCELL ACTIVATION

(71) Applicant: MEDIATEK INC, Hsin-Chu (TW)

(72) Inventors: Chih-Kai Yang, Hsin-Chu (TW); Tsang-Wei Yu, Hsin-Chu (TW); Chi-Hsuan Hsieh, Hsin-Chu (TW); Din-Hwa Huang, Hsin-Chu (TW); Ming-Yuan Cheng, Hsin-Chu (TW)

(21) Appl. No.: 17/945,069

(22) Filed: Sep. 14, 2022

Related U.S. Application Data
(60) Provisional application No. 63/250,297, filed on Sep. 30, 2021.
(60) Provisional application No. 63/250,300, filed on Sep. 30, 2021.

(51) Int. Cl. H04L 5/00; H04W 72/12; H04W 72/14

(52) U.S. Cl. CPC H04L 5/0035; H04W 72/1284; H04W 72/1289; H04W 72/14; H04L 5/0098

(57) ABSTRACT

Apparatus and methods for unknown physical uplink control channel (PUCCH) secondary cell (SCell) activation are proposed. The network node may transmit a PUCCH SCell activation command for an unknown target PUCCH SCell to the UE. After receiving the PUCCH SCell activation command for the unknown target PUCCH SCell, the UE may transmit a layer 1 (L1) report or a layer 3 (L3) report for the unknown target PUCCH SCell to the network node before the unknown target PUCCH SCell is activated. The network node may obtain measurement information based on the L1 report or the L3 report before the unknown target PUCCH SCell is activated. Then, the network node may perform corresponding operations based on the L1 report or the L3 report before the unknown target PUCCH SCell is activated.

### CROSS REFERENCE TO RELATED APPLICATIONS

This application claims priority under 35 U.S.C. § 119 from U.S. Provisional Application No. 63/250,297, entitled “Using aperiodic/semi-persistent report for unknown PUCCH SCell activation in NR”, filed on Sep. 30, 2021, and U.S. Provisional Application No. 63/250,300, entitled “PUCCH SCell activation procedure for unknown case in NR”, filed on Sep. 30, 2021, the subject matter of which is incorporated herein by reference.

### TECHNICAL FIELD

The disclosed embodiments relate generally to wireless communication, and, more particularly, to methods for unknown physical uplink control channel (PUCCH) secondary cell (SCell) activation.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board has decided to focus the future NGMN activities on defining the end-to-end requirements for 5G new radio (NR) systems.

In conventional 5G technology, the network node may transmit an activation command for a physical uplink control channel (PUCCH) secondary cell (SCell) to the UE. However, the PUCCH SCell may be an unknown PUCCH SCell defined in 3GPP Technical Specification (TS) 38.133. The PUCCH SCell is unknown if one of following condition is met. (1) UE does not send a valid measurement report for the PUCCH SCell being activated before the UE receives the SCell activation command. (2) the SSB measured does not remain detectable before the UE receives the SCell activation command. (3) the SSB measured does not remain detectable during the SCell activation. The detectable conditions in the above conditions can refer to clause 9 in TS 38.133. For an unknown PUCCH SCell with valid timing advance (TA) or invalid TA case, the measurement report may not be transmitted successfully on the activating PUCCH SCell to the network. In that case, network cannot indicate the instructions for activation to the UE, e.g., downlink TCI state indication, uplink spatial relation indication, configuration of CSI reporting and PDCCH order for PRACH transmission. Eventually, the activation of unknown PUCCH SCell is failed.

Therefore, how can the unknown PUCCH SCell with valid TA or invalid TA be activated successfully is worthy of discussion.

### SUMMARY

Apparatus and methods for unknown PUCCH SCell activation are proposed. The network node may transmit a PUCCH SCell activation command for an unknown target PUCCH SCell to the UE. After receiving the PUCCH SCell activation command for the unknown target PUCCH SCell, the UE may transmit a layer 1 (L1) report or a layer 3 (L3) report for the unknown target PUCCH SCell to the network node before the unknown target PUCCH SCell is activated. The network node may obtain the measurement information based on the L1 report or the L3 report before the unknown target PUCCH SCell is activated. Then, the network node may perform corresponding operations based on the L1 report or the L3 report before the unknown target PUCCH SCell is activated. Therefore, the unknown PUCCH SCell with valid TA or invalid TA can be activated successfully.

In one embodiment, a user equipment (UE) receives a physical uplink control channel (PUCCH) secondary cell (SCell) activation command for an unknown target PUCCH SCell from a network code. Then, the UE transmits a layer 1 (L1) report or a layer 3 (L3) report for the unknown target PUCCH SCell to the network node through an uplink channel on a special cell (SpCell) or a SCell before the unknown target PUCCH SCell is activated.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a simplified block diagram of a network node and a user equipment that carry out certain embodiments of the present invention.

FIG. 2 is a flow chart of PUCCH SCell activation method for unknown PUCCH SCell with valid TA in accordance with one novel aspect.

FIG. 3 is a flow chart of PUCCH SCell activation method for unknown PUCCH SCell with invalid TA in accordance with one novel aspect.

FIG. 4 is a flow chart of PUCCH SCell activation method for unknown PUCCH SCell in accordance with one novel aspect.

### DETAILED DESCRIPTION

Reference will now be made in detail to some embodiments of the invention, examples of which are illustrated in the accompanying drawings.

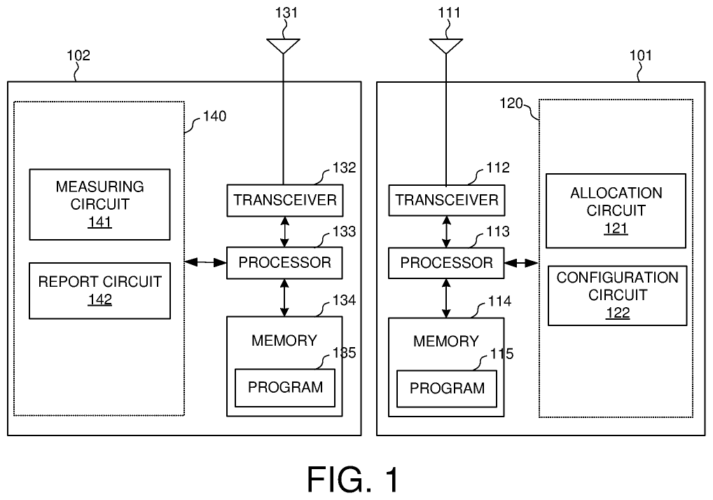

FIG. 1 is a simplified block diagram of a network node and a user equipment (UE) that carry out certain embodiments of the present invention. The network node 101 may be a base station (BS) or a gNB, but the present invention should not be limited thereto. The UE 102 may be a smart phone, a wearable device, an Internet of Things (IoT) device, and a tablet, etc. Alternatively, UE 102 may be a Notebook (NB) or Personal Computer (PC) inserted or installed with a data card which includes a modem and RF transceiver(s) to provide the functionality of wireless communication.

Network node 101 has an antenna array 111 having multiple antenna elements that transmits and receives radio signals, one or more RF transceiver modules 112, coupled with the antenna array 111, receives RF signals from antenna array 111, converts them to baseband signal, and sends them to processor 113. RF transceiver 112 also converts received baseband signals from processor 113, converts them to RF signals, and sends out to antenna array 111. Processor 113 processes the received baseband signals and invokes different functional modules and circuits 120 to perform features in network node 101. Memory 114 stores program instructions and data 115 to control the operations of network node 101. Network node 101 also includes multiple function modules that carry out different tasks in accordance with embodiments of the current invention.

Similarly, UE 102 has an antenna array 131, which transmits and receives radio signals. A RF transceiver 132, coupled with the antenna, receives RF signals from antenna array 131, converts them to baseband signals and sends them to processor 133. RF transceiver 132 also converts received baseband signals from processor 133, converts them to RF signals, and sends out to antenna array 131. Processor 133 processes the received baseband signals and invokes different functional modules and circuits 140 to perform features in UE 102. Memory 134 stores program instructions and data 135 to control the operations of UE 102. UE 102 also includes multiple function modules and circuits that carry out different tasks in accordance with embodiments of the current invention.

The functional modules and circuits 120 and 140 can be implemented and configured by hardware, firmware, software, and any combination thereof. The function modules and circuits 120 and 140, when executed by the processors 113 and 133 (e.g., via executing program codes 115 and 135), allow network node 101 and UE 102 to perform embodiments of the present invention.

In the example of FIG. 1, the network node 101 may comprise an allocation circuit 121 and a configuration circuit 122. Allocation circuit 121 may generate a physical uplink control channel (PUCCH) secondary cell (SCell) activation command for a target PUCCH SCell. Configuration circuit 122 may transmit the PUCCH SCell activation command to the UE 102.

In the example of FIG. 1, the UE 102 may comprise a measuring circuit 141 and a report circuit 142. measuring circuit 141 may perform measurements based on the configurations from the network node 101 or other network nodes. Report circuit 142 may transmit a layer 1 (L1) report or a layer 3 (L3) report for an unknown target PUCCH SCell to the network node 101 based on the measurement results for the unknown target PUCCH SCell from the measuring circuit 141.

In accordance with one novel aspect, when the UE 102 receives a PUCCH SCell activation command for an unknown target PUCCH SCell from the network node 101, the UE 102 may transmit a L1 report or a L3 report for the unknown target PUCCH SCell to the network node 101 through an uplink channel on a special cell (SpCell) or a SCell before the unknown target PUCCH SCell is activated. Then, the network node 101 may indicate at least one of following instructions, downlink transmission control information (TCI) indicator, uplink spatial relation indication, channel state information (CSI) resource configuration, CSI reporting configuration and PDCCH order for physical random access channel (PRACH) transmission, based on the L1 report or the L3 report before the unknown target PUCCH SCell is activated. The SpCell may comprise at least one of a primary cell (PCell) and a primary secondary cell (PSCell). The unknown target PUCCH SCell may be in a frequency range 1 (FR1) band or in a frequency range 2 (FR2) band.

In accordance with one novel aspect, the unknown target PUCCH SCell may belong to a PUCCH group (e.g., a secondary PUCCH group). The L1 report or L3 report may be transmitted through an active serving cell within a PUCCH group which is different from the PUCCH group associated with the unknown target PUCCH SCell. In an example, if the unknown target PUCCH SCell belongs to a PUCCH group, the UE 102 may transmit a L1 report or a L3 report for the unknown target PUCCH SCell to the network node 101 through an uplink channel on a special cell (SpCell) or a SCell which belongs to another PUCCH group before the unknown target PUCCH SCell is activated. That is, the UE 102 may have capability of transmitting report (e.g., channel state information (CSI) report, L1 report or a L3 report) cross PUCCH group.

The uplink channel may comprise at least one of a physical uplink shared channel (PUSCH) or a PUCCH. In an example, the UE 102 may transmit a L1 report for the unknown target PUCCH SCell through a PUCCH on a SpCell before the unknown target PUCCH SCell is activated. In another example, the UE 102 may transmit a L1 report for the unknown target PUCCH SCell through a PUSCH on a SpCell or a SCell before the unknown target PUCCH SCell is activated. In another example, the UE 102 may transmit a L3 report for the unknown target PUCCH SCell through a PUSCH on a SpCell or a SCell before the unknown target PUCCH SCell is activated.

In an example, the L1 report may comprise L1-reference signal received power (L1-RSRP) measurement, L1-signal to interference plus noise ratio (L1-SINR) measurement, channel quality indicator (CQI), precoding matrix indicator (PMI), rank indicator (RI), or channel-state-information reference-signal (CSI-RS) resource indicator (CRI). The L1 report may be an aperiodic L1 report or a semi-persistent L1 report.

In an example, the L3 report may comprise a L3-RSRP measurement report or a synchronization-signal SINR (SS-SINR) measurement report.

The unknown target PUCCH SCell may be associated with a valid timing advance (TA) or an invalid TA. In an example, when the unknown target PUCCH SCell is associated with the invalid TA, after the UE 102 transmits the L1 report or the L3 report for the unknown target PUCCH SCell to the network node 101, the UE 102 may receive a PDCCH order from the network node 101. Then, the UE 102 may transmit information related to a physical random access channel (PRACH) transmission to another network node associated with the unknown target PUCCH SCell.

In an embodiment, the unknown target PUCCH SCell is associated with the valid TA and belongs to FR1. When the UE 102 receives the PUCCH SCell activation command for the unknown target PUCCH SCell from the network node 101 in slot n, the unknown target PUCCH SCell is activated no later than in slot

$$n + \frac{{T}_{H A R Q} + {T}_{activation \_ time} + {T}_{CSI \_ Reporting}}{slot length} .$$

T_{HARQ} is the timing between downlink (DL) data transmission and acknowledgement. T_{CSI_Reporting} is the delay including uncertainty in acquiring the first available downlink CSI reference resource. T_{activation_time} is the activation time for the unknown target PUCCH SCell. In the embodiment, the side condition Ês/lot≥−2 dB is fulfilled.

In the embodiment, if the UE 102 transmits the L1 report for the unknown target PUCCH SCell through a PUCCH on a SpCell or through a PUSCH on a SpCell or a SCell before the unknown target PUCCH SCell is activated, the T_{activation_time} is defined as follow:

6 ms+T_{FirstSSB_MAX}+T_{SMTC_MAX}+Tᵣₛ+T_{L1-RSRP,measure}+T_{L1-RSRP,report}+T_{HARQ}+max (T_{uncertainty_MAC}+T_{FineTiming}+2 ms T_{uncertainty_SP}), if semi-persistent CSI-RS is used for CSI reporting, or

3 ms+T_{FirstSSB_MAX}+T_{SMTC_MAX}+Tᵣₛ+T_{L1-RSRP,measure}+T_{L1-RSRP,report}+max (T_{HARQ}+T_{uncertainty_MAC}+5 ms+T_{FineTiming}, T_{uncertainty_RRC}+T_{RRC_delay}), if periodic CSI-RS is used for CSI reporting. T_{FirstSSB_MAX} is the time to the end of the first complete synchronization signal/PBCH block (SSB) burst indicated by the SSB measurement timing configuration (SMTC) after slot

$$n + \frac{{T}_{H A R Q} + 3 m s}{slot length} .$$

T_{SMTC_MAX} is the longer SMTC periodicity between active serving cells and SCell being activated in case of intra-band SCell activation or the SMTC periodicity of SCell being activated in case of inter-band SCell activation. Tᵣₛ is the SMTC periodicity of SCell being activated or set to 5 ms. T_{L1-RSRP,measure} is a L1-RSRP measurement delay. T_{L1-RSRP,report} is a delay of acquiring CSI reporting resources. T_{unceaainty_MAC} is the time period between reception of the last activation command. T_{FineTiming} is the time period between UE finish processing the last activation command. T_{unceaainty_SP} is the time period between reception of the activation command for semi-persistent CSI-RS resource set for CQI reporting. T_{unceaainty_RRC} is the time period between reception of the RRC configuration message for TCI of periodic CSI-RS for CQI reporting. T_{RRC_delay} is the RRC procedure delay. Details for the above parameters are defined in 3GPP TS 38.213 and TS38.331.

In the embodiment, if the UE 102 transmits the L3 report for the unknown target PUCCH SCell through a PUSCH on a SpCell or a SCell before the unknown target PUCCH SCell is activated, the T_{activation_time} is defined as follow:

6 ms+T_{FirstSSB_MAX}+T_{SMTC_MAX}+Tᵣₛ+T_{L3-RSRP}+T_{HARQ}+max (T_{uncertainty_MAC}+T_{FineTiming}+2 ms, T_{uncertainty_SP}), if semi-persistent CSI-RS is used for CSI reporting, and

3 ms+T_{FirstSSB_MAX}+T_{SMTC_MAX}+Tᵣₛ+T_{L3-RSRP}+max (T_{HARQ}+T_{uncertainty_MAC}+5 ms+T_{FineTiming}, T_{uncertainty_RRC}+T_{RRC_delay}), if periodic CSI-RS is used for CSI reporting. T_{L3-RSRP} is the T_{identify intra without index} or T_{identify intra with index} defined in clause 9.2 in 3GPP TS 38.133.

In another embodiment, the unknown target PUCCH SCell is associated with the invalid TA and belongs to FR1. When the UE 102 receives the PUCCH SCell activation command for the unknown target PUCCH SCell from the network node 101 in slot n, the unknown target PUCCH SCell is activated no later than in slot

$$n + \frac{{T}_{H A R Q} + {T}_{activation \_ time} + {T}_{CSI \_ Reporting}}{slot length} + T 1 + T 2 + T 3.$$

T_{HARQ} is the timing between downlink (DL) data transmission and acknowledgement. T_{CSI_Reporting} is the delay including uncertainty in acquiring the first available downlink CSI reference resource. T_{activation_time} is the activation time for the unknown target PUCCH SCell. T1 is the delay uncertainty in acquiring the first available PRACH occasion in the PUCCH SCell. T2 is the delay for obtaining a valid TA command for the secondary timing-advance group (sTAG) to which the SCell configured with PUCCH belongs. T3 is the delay for applying the received TA for uplink transmission. In the embodiment, the side condition Ês/lot≥−2 dB is fulfilled.

In the embodiment, if the UE 102 transmits the L1 report for the unknown target PUCCH SCell through a PUCCH on a SpCell or through a PUSCH on a SpCell or a SCell before the unknown target PUCCH SCell is activated, the T_{activation_time} is defined as follow:

6 ms+T_{FirstSSB_MAX}+T_{SMTC_MAX}+Tᵣₛ+T_{L1-RSRP,measure}+T_{L1-RSRP,report}+T_{HARQ}+max (T_{uncertainty_MAC}+T_{FineTiming}+2 ms, T_{uncertainty_SP}), if semi-persistent CSI-RS is used for CSI reporting, and

3 ms+T_{FirstSSB_MAX}+T_{SMTC_MAX}+Tᵣₛ+T_{L1-RSRP,measure}+T_{L1-RSRP,report}+max (T_{HARQ}+T_{uncertainty_MAC}+5 ms+T_{FineTiming}, T_{uncertainty_RRC}+T_{RRC_delay}), if periodic CSI-RS is used for CSI reporting.

In the embodiment, if the UE 102 transmits the L3 report for the unknown target PUCCH SCell through a PUSCH on a SpCell or a SCell before the unknown target PUCCH SCell is activated, the T_{activation time} is defined as follow:

6 ms+T_{FirstSSB_MAX}+T_{SMTC_MAX}+Tᵣₛ+T_{L3-RSRP}+T_{HARQ}+max (T_{uncertainty_MAC}+T_{FineTiming}+2 ms, T_{uncertainty_SP}), if semi-persistent CSI-RS is used for CSI reporting, and

3 ms+T_{FirstSSB_MAX}+T_{SMTC_MAX}+Tᵣₛ+T_{L3-RSRP}+max (T_{HARQ}+T_{uncertainty_MAC}+5 ms+T_{FineTiming}, T_{uncertainty_RRC}+T_{RRC_delay}), if periodic CSI-RS is used for CSI reporting. T_{L3-RSRP} is a L3 RSRP delay, e.g., the T_{identify intra without index} or T_{identify intra with index} defined in clause 9.2 in 3GPP TS 38.133.

In another embodiment, the unknown target PUCCH SCell is associated with the valid TA and belongs to FR2. When the UE 102 receives the PUCCH SCell activation command for the unknown target PUCCH SCell from the network node 101 in slot n, the unknown target PUCCH SCell is activated no later than in slot

$$n + \frac{{T}_{H A R Q} + {T}_{activation \_ time} + {T}_{CSI \_ Reporting}}{slot length} .$$

T_{HARQ} is the timing between downlink (DL) data transmission and acknowledgement. T_{CSI_Reporting} is the delay including uncertainty in acquiring the first available downlink CSI reference resource. T_{activation_time} is the activation time for the unknown target PUCCH SCell. In the embodiment, the side condition Ês/lot≥−2 dB is fulfilled.

In the embodiment, if the UE 102 transmits the L1 report for the unknown target PUCCH SCell through a PUCCH on a SpCell or through a PUSCH on a SpCell or a SCell before the unknown target PUCCH SCell is activated, the T_{activation_time} is defined as follow:

6 ms+T_{FirstSSB_MAX}+15*T_{SMTC_MAX}+8*Tᵣₛ+T_{L1-RSRP,measure}+T_{L1-RSRP,report}+T_{HARQ}+max (T_{uncertainty_MAC}+T_{FineTiming}+2 ms, T_{uncertainty_SP}), if semi-persistent CSI-RS is used for CSI reporting, and

3 ms+T_{FirstSSB_MAX}+15*T_{SMTC_MAX}+8*Tᵣₛ+T_{L1-RSRP,measure}+T_{L1-RSRP,report}+max (T_{HARQ}+T_{uncertainty_MAC}+5 ms+T_{FineTiming}, T_{uncertainty_RRC}+T_{RRC_delay}), if periodic CSI-RS is used for CSI reporting.

In the embodiment, if the UE 102 transmits the L3 report for the unknown target PUCCH SCell through a PUSCH on a SpCell or a SCell before the unknown target PUCCH SCell is activated, the T_{activation_time} is defined as follow:

6 ms+T_{FirstSSB_MAX}+15*T_{SMTC_MAX}+8*Tᵣₛ+ T_{L3-RSRP}+ T_{HARQ}+max (T_{uncertainty_MAC}+T_{FineTiming}+2 ms, T_{uncertainty_SP}), if semi-persistent CSI-RS is used for CSI reporting, and

3 ms+T_{FirstSSB_MAX}+15*T_{SMTC_MAX}+8*Tᵣₛ+T_{L3-RSRP}+max (T_{HARQ}+T_{uncertainty_MAC}+5 ms+T_{FineTiming}, T_{uncertainty_RRC}+T_{RRC_delay}), if periodic CSI-RS is used for CSI reporting. T_{L3-RSRP} is a L3 RSRP delay, e.g., the T_{identify intra without index} or T_{identify intra with index} defined in clause 9.2 in 3GPP TS 38.133.

In another embodiment, the unknown target PUCCH SCell is associated with the invalid TA and belongs to FR2. When the UE 102 receives the PUCCH SCell activation command for the unknown target PUCCH SCell from the network node 101 in slot n, the unknown target PUCCH SCell is activated no later than in slot

$$n + \frac{{T}_{H A R Q} + {T}_{activation \_ time} + {T}_{CSI \_ Reporting}}{slot length} + T 1 + T 2 + T 3.$$

T_{HARQ} is the timing between downlink (DL) data transmission and acknowledgement. T_{CSI_Reporting} is the delay including uncertainty in acquiring the first available downlink CSI reference resource. T_{activation_time} is the activation time for the unknown target PUCCH SCell. T1 is the delay uncertainty in acquiring the first available PRACH occasion in the PUCCH SCell. T2 is the delay for obtaining a valid TA command for the secondary timing-advance group (sTAG) to which the SCell configured with PUCCH belongs. T3 is the delay for applying the received TA for uplink transmission.

In the embodiment, the side condition Ês/lot≥−2 dB is fulfilled.

In the embodiment, if the UE 102 transmits the L1 report for the unknown target PUCCH SCell through a PUCCH on a SpCell or through a PUSCH on a SpCell or a SCell before the unknown target PUCCH SCell is activated, the T_{activation time} is defined as follow:

6 ms+T_{FirstSSB_MAX}+15*T_{SMTC_MAX}+8*Tᵣₛ+T_{L1-RSRP,measure}+T_{L1-RSRP,report}+T_{HARQ}+max (T_{uncertainty_MAC}+T_{FineTiming}+2 ms, T_{uncertainty SP}), if semi-persistent CSI-RS is used for CSI reporting, and

3 ms+T_{FirstSSB_MAX}+15*T_{SMTC_MAX}+8*Tᵣₛ+T_{L1-RSRP,measure}+T_{L1-RSRP,report}+max (T_{HARQ}+T_{uncertainty_MAC}+5 ms+T_{FineTiming}, T_{uncertainty_RRC}+T_{RRC_delay}), if periodic CSI-RS is used for CSI reporting.

In the embodiment, if the UE 102 transmits the L3 report for the unknown target PUCCH SCell through a PUSCH on a SpCell or a SCell before the unknown target PUCCH SCell is activated, the T_{activation_time} is defined as follow:

6 ms+T_{FirstSSB_MAX}+15*T_{SMTC_MAX}+8*Tᵣₛ+T_{L3-RSRP}+T_{HARQ}+max (T_{uncertainty_MAC}+T_{FineTiming}+2 ms, T_{uncertainty_SP}), if semi-persistent CSI-RS is used for CSI reporting, and

3 ms+T_{FirstSSB_MAX}+15*T_{SMTC_MAX}+8*Tᵣₛ+T_{L3-RSRP}+max (T_{HARQ}+T_{uncertainty_MAC}+5 ms+T_{FineTiming}, T_{uncertainty_RRC}+T_{RRC_delay}), if periodic CSI-RS is used for CSI reporting. T_{L3-RSRP} is a L3 RSRP delay, e.g., the T_{identify intra without index} or T_{identify intra with index} defined in clause 9.2 in 3GPP TS 38.133.

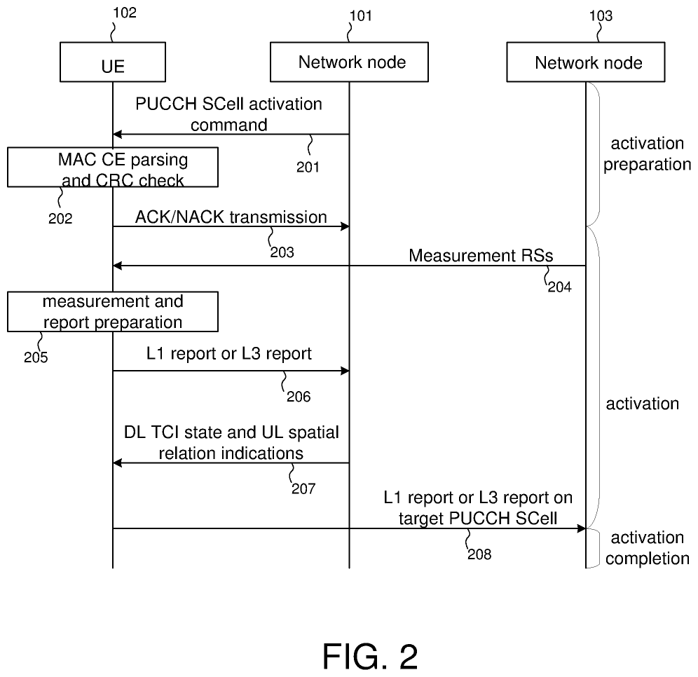

FIG. 2 is a flow chart of PUCCH SCell activation method for unknown PUCCH SCell with valid TA in accordance with one novel aspect. In the present invention, the unknown PUCCH SCell belongs to a secondary PUCCH group.

In step 201, the UE 102 may receive a PUCCH SCell activation command for an unknown target PUCCH SCell from the network 101 through a primary cell (PCell).

In step 202, the UE 102 may perform medium-access control control-element (MAC CE) parsing and cyclic redundancy check (CRC) check.

In step 203, the UE 102 may transmit ACK/NACK signal to the network node 101.

In step 204, the network node 103 associated with the unknown target PUCCH SCell may transmit measurement reference signals (RSs) for the unknown target PUCCH SCell to the UE 102.

In step 205, the UE 102 may perform measurement based on the measurement RSs to generate the L1 report or L3 report for the unknown target PUCCH SCell.

In step 206, the UE 102 may transmit the L1 report or L3 report for the unknown target PUCCH SCell to the network node 101.

In step 207, the network node 101 may transmit the downlink (DL) transmission configuration indicator (TCI) state and uplink (UL) spatial relation indicators to the UE 102 based on the L1 report or L3 report for the unknown target PUCCH SCell. From step 204 to step 207, during the activation procedure for the unknown target PUCCH SCell, the unknown target PUCCH SCell has not been activated completely.

In step 208, the unknown target PUCCH SCell activation has been completed, and the UE 102 may transmit the L1 report or L3 report for the unknown target PUCCH SCell to the network node 101 through the unknown target PUCCH SCell.

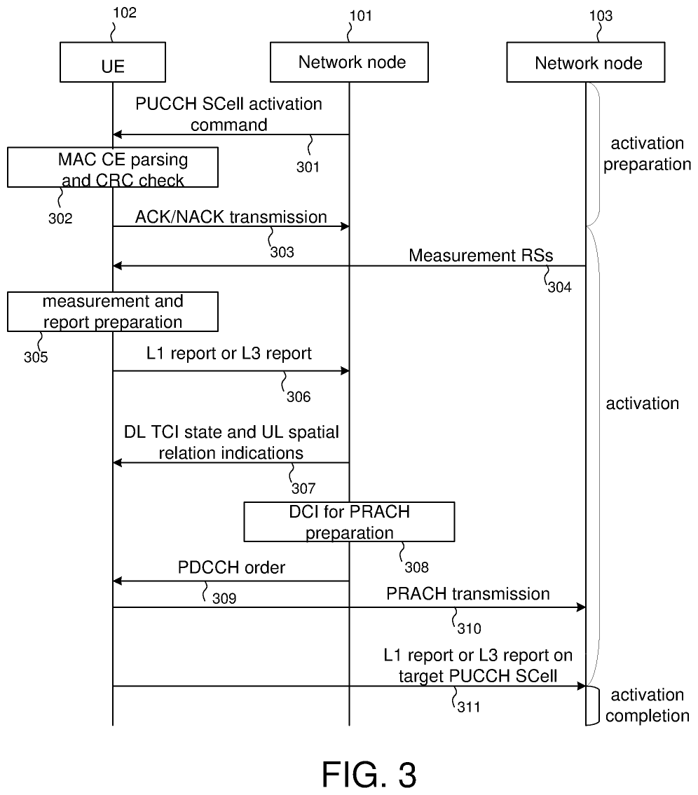

FIG. 3 is a flow chart of PUCCH SCell activation method for unknown PUCCH SCell with invalid TA in accordance with one novel aspect. In the present invention, the unknown PUCCH SCell belongs to a secondary PUCCH group.

In step 301, the UE 102 may receive a PUCCH SCell activation command for an unknown target PUCCH SCell from the network 101 through a primary cell (PCell).

In step 302, the UE 102 may perform medium-access control control-element (MAC CE) parsing and cyclic redundancy check (CRC) check.

In step 303, the UE 102 may transmit ACK/NACK signal to the network node 101.

In step 304, the network node 103 associated with the unknown target PUCCH SCell may transmit measurement reference signals (RSs) for the unknown target PUCCH SCell to the UE 102.

In step 305, the UE 102 may perform measurement based on the measurement RSs to generate the L1 report or L3 report for the unknown target PUCCH SCell.

In step 306, the UE 102 may transmit the L1 report or L3 report for the unknown target PUCCH SCell to the network node 101.

In step 307, the network node 101 may transmit the downlink (DL) transmission configuration indicator (TCI) state and uplink (UL) spatial relation indicators to the UE 102 based on the L1 report or L3 report for the unknown target PUCCH SCell.

In step 308, the network node 101 may generate the downlink control information (DCI) for a physical random access channel (PRACH) transmission.

In step 309, the network node 101 may transmit a PDCCH order to the UE 102.

In step 310, the UE 102 may transmit information related to the PRACH transmission to the network node 103 associated with the unknown target PUCCH SCell. From step 304 to step 310, during the activation procedure for the unknown target PUCCH SCell, the unknown target PUCCH SCell has not been activated completely.

In step 311, the unknown target PUCCH SCell activation has been completed, and the UE 102 may transmit the L1 report or L3 report for the unknown target PUCCH SCell to the network node 101 through the unknown target PUCCH SCell.

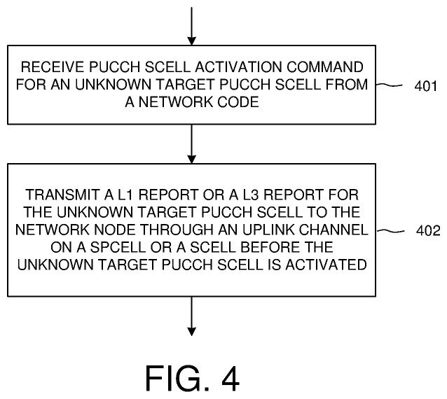

FIG. 4 is a flow chart of PUCCH SCell activation method for unknown PUCCH SCell in accordance with one novel aspect. In step 401, a UE receives a physical uplink control channel (PUCCH) secondary cell (SCell) activation command for an unknown target PUCCH SCell from a network code.

In step 402, the UE transmits a layer 1 (L1) report or a layer 3 (L3) report for the unknown target PUCCH SCell to the network node through an uplink channel on a special cell (SpCell) or a SCell before the unknown target PUCCH SCell is activated.

In activation method for unknown PUCCH SCell, the uplink channel may comprise at least one of a physical uplink shared channel (PUSCH) or a PUCCH.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving, by a user equipment (UE), a physical uplink control channel (PUCCH) secondary cell (SCell) activation command for an unknown target PUCCH SCell from a network code; and
transmitting, by the UE, a layer 1 (L1) report or a layer 3 (L3) report for the unknown target PUCCH SCell to the network node through an uplink channel on a special cell (SpCell) or an SCell before the unknown target PUCCH SCell is activated.

2. The method of claim 1, wherein the uplink channel comprises at least one of a physical uplink shared channel (PUSCH) or a PUCCH.

3. The method of claim 1, wherein the SpCell comprises at least one of a primary cell (PCell) and a primary secondary cell (PSCell).

4. The method of claim 1, wherein the unknown target PUCCH SCell is associated with a valid timing advance (TA) or an invalid TA.

5. The method of claim 4, wherein in an event that the unknown target PUCCH SCell is associated with the invalid TA, the method further comprises:
receiving, by the UE, a PDCCH order from the network node; and
transmitting, by the UE, information related to a physical random access channel (PRACH) transmission to another network node associated with the unknown target PUCCH SCell.

6. The method of claim 1, wherein the unknown target PUCCH SCell is in a frequency range 1 (FR1) band or in a frequency range 2 (FR2) band.

7. The method of claim 1, wherein the L1 report comprises L1-reference signal received power (L1-RSRP) measurement, L1-signal to interference plus noise ratio (L1-SINR) measurement, channel quality indicator (CQI), precoding matrix indicator (PMI), rank indicator (RI), or channel-state-information reference-signal (CSI-RS) resource indicator (CRI).

8. The method of claim 1, wherein the L1 report comprises an aperiodic L1 report or a semi-persistent L1 report.

9. The method of claim 1, wherein the L3 report comprises a L3-RSRP measurement report or a synchronization-signal SINR (SS-SINR) measurement report.

10. The method of claim 1, wherein an activation time of the unknown target PUCCH SCell comprises a L3 RSRP delay.

11. A user equipment (UE), comprising:
a receiver, receiving a physical uplink control channel (PUCCH) secondary cell (SCell) activation command for an unknown target PUCCH SCell from a network code; and
a transmitter, transmitting a layer 1 (L1) report or a layer 3 (L3) report for the unknown target PUCCH SCell to the network node through an uplink channel on a special cell (SpCell) or an SCell before the unknown target PUCCH SCell is activated.

12. The UE of claim 11, wherein the uplink channel comprises at least one of a physical uplink shared channel (PUSCH) or a PUCCH.

13. The UE of claim 11, wherein the SpCell comprises at least one of a primary cell (PCell) or a primary secondary cell (PSCell).

14. The UE of claim 11, wherein the unknown target PUCCH SCell is associated with a valid timing advance (TA) or an invalid TA.

15. The UE of claim 14, wherein in an event that the unknown target PUCCH SCell is associated with the invalid TA, the receiver receives a PDCCH order from the network node and the transmitter transmits information related to a physical random access channel (PRACH) transmission to another network node associated with the unknown target PUCCH SCell.

16. The UE of claim 11, wherein the unknown target PUCCH SCell is in a frequency range 1 (FR1) band or in a frequency range 2 (FR2) band.

17. The UE of claim 11, wherein the L1 report comprises L1-reference signal received power (L1-RSRP) measurement, L1-signal to interference plus noise ratio (L1-SINR) measurement, channel quality indicator (CQI), precoding matrix indicator (PMI), rank indicator (RI), or channel-state-information reference-signal (CSI-RS) resource indicator (CRI).

18. The UE of claim 11, wherein the L1 report comprises an aperiodic L1 report or a semi-persistent L1 report.

19. The UE of claim 11, wherein the L3 report comprises a L3-RSRP measurement report or a synchronization-signal SINR (SS-SINR) measurement report.

20. The UE of claim 11, wherein an activation time of the unknown target PUCCH SCell comprises a L3 RSRP delay.
